(19) United States
(12) Patent Application Publication
(10) Pub. No.: US 2004/0192855 A1
(43) Pub. Date: Sep. 30, 2004

(54) Polymer mixture having improved rheological properties and improved shrinking behaviour

(76) Inventors: Igor Emri, Ljubljana (SI); Bernd-Steffen von Bernstorff, Wachenheim (DE); Volker Rauschenberger, Eisenberg (DE); Hans Christoph Horn, Lambsheim (DE)

Correspondence Address: KEIL & WEINKAUF, 1350 CONNECTICUT AVENUE, N.W., WASHINGTON, DC, 20036, US

(21) Appl. No.: 10/480,195

(22) PCT Filed: Jun. 14, 2002
(86) PCT No.: PCT/EP02/06548

(30) Foreign Application Priority Data
Jun. 21, 2001 (DE) 101 29 522.7

(51) Int. Cl. C08G 63/68

(52) U.S. Cl. 525/418

(57) ABSTRACT

The invention relates to a thermoplastic polymer mixture containing m, m representing a natural number higher than 1, polymers Pₙ wherein n represents a natural number between 1 and m, and at least one recurring functional group contained in the Pₙ polymer chain, said group(s) having the structure —(R¹)ₓ—C(O)—(R²)_{y}— wherein x and y independently represent 0 or 1, and x+y=1, and R¹, R² independently represent oxygen or nitrogen linked into the main polymer chain. The polymers Pₙ differ in terms of at least one characteristic related to molecular weight. The polymer mixture has a number average molecular weight Mₙ(P)₁, a weight average molecular weight M_{w}(P)₁, a Z average molecular weight M_{z}(P)₁, a heterogeneity index M_{w}(P)₁/Mₙ(P)₁, and a molecular weight Mₚ(P)₁ defined according to DIN 55672-2 in hexafluoroisopropanol as an elution agent. After maintaining the polymer mixture at the melting point of the same, defined according to ISO 11357-1 and 11357-3, for five minutes, the polymer mixture has a number average molecular weight Mₙ(P)₂, a weight average molecular weight M_{w}(P)₂, a Z average molecular weight M_{z}(P)₂, a heterogeneity index M_{w}(P)₂/Mₙ(P)₂, and a molecular weight Mₚ(P)₂ defined according to DIN 55672-2 in hexafluoroisopropanol as an elution agent. The values Mₙ(P)₂, M_{w}(P)₂, M_{z}(P)₂, M_{w}(P)₂/Mₙ(P)₂ and Mₚ(P)₂ lie within the triple replication standard deviation sigma (r) in relation to Mₙ(P)₁, M_{w}(P)₁, M_{z}(P)₁, M_{w}(P)₁/Mₙ(P)₁ and Mₚ(P)₁ according to DIN 55672-2 in hexafluoroisopropanol as an elution agent.

The present invention relates to a thermoplastic polymer mixture comprising m polymers Pₙ, where m is a natural number greater than 1, and where each of the polymers has

a) one or more functional groups of the structure

—(R¹)ₓ—C(O)—(R²)_{y}—

present as repeat units in the polymer chain of Pₙ

where

x and y, independently of one another, are 0 or 1, and x+y=1

R¹ and R², independently of one another, are oxygen or nitrogen bonded into the main polymer chain,

b) a number-average molecular weight Mₙ(Pₙ) to DIN 55672-2 in hexafluoroisopropanol as eluent,

c) a weight-average molecular weight M_{w}(Pₙ) to DIN 55672-2 in hexafluoroisopropanol as eluent,

d) a z-average molecular weight M_{z}(Pₙ) to DIN 55672-2 in hexafluoroisopropanol as eluent,

e) a heterogeneity index M_{w}(Pₙ)/Mₙ(Pₙ) to DIN 55672-2 in hexafluoroisopropanol as eluent, and

f) a molecular weight Mₚ(Pₙ) to DIN 55672-2 in hexafluoroisopropanol as eluent,

and the polymers Pₙ differ from one another in 1, 2, 3, 4, 5, or 6 of the properties a), b), c), d), e), and f),

and where the polymer mixture

has a number-average molecular weight Mₙ(P)₁, a weight-average molecular weight M_{w}(P)₁, a z-average molecular weight M_{z}(P)₁, a heterogeneity index M_{w}(P)₁/Mₙ(P)₁, and a molecular weight Mₚ(P)₁ determined to DIN 55672-2 in hexafluoroisopropanol as eluent,

and after aging of the polymer mixture at the melting point of the polymer mixture determined to ISO 11357-1 and 11357-3 for 5 minutes has a number-average molecular weight Mₙ(P)₂, a weight-average molecular weight M_{w}(P)₂, a z-average molecular

weight M_{z}(P)₂, a heterogeneity index M_{w}(P)₂/Mₙ(P)₂, and a molecular weight Mₚ(P)₂ determined to DIN 55672-2 in hexafluoroisopropanol as eluent, and

these values Mₙ(P)₂, M_{w}(P)₂, M_{z}(P)₂, M_{w}(P)₂/Mₙ(P)₂ and Mₚ(P)₂ lie within the value of three times the recurrent standard deviation in sigma(r) based on Mₙ(P)₁, M_{w}(P)₁, M_{z}(P)₁, M_{w}(P)₁/Mₙ(P)₁ and Mₚ(P)₁ to DIN 55672-2 in hexafluoroisopropanol as eluent.

The invention further relates to a process for preparing a polymer mixture of this type, and also to fibers, sheets, and moldings obtainable using this polymer mixture.

There are well known thermoplastic polymers Pₙ, where each of the polymers has one or more functional groups of the structure

—(R¹)ₓ—C(O)—(R²)_{y}—

present as repeat units in the polymer chain of Pₙ

where

x and y, independently of one another, are 0 or 1, and x+y=1

R¹ and R², independently of one another, are oxygen or nitrogen bonded into the main polymer chain,

for example polyamides, polyesters, and polyesteramides. The production of fibers, sheets and moldings using these polymers is also well known.

During the production of fibers, sheets, or moldings it is usual for solids to be admixed with the polymer, for example pigments such as titanium dioxide in the case of the fibers, or glass particles, such as glass fibers or glass beads in the case of the moldings. These mixtures are then usually processed in the melt using spinning dies to give fibers, or to give sheets, or by injection molding to give moldings.

A disadvantage with mixtures of this type is that increasing solids content markedly impairs the rheological properties of the mixtures. For example, the viscosity of the melt increases, and this can be observed as a reduction in flowability to EN ISO 1133. The increase in the viscosity causes undesirable pressure build-up in the apparatus conveying the mixture to the spinning dies or injection molds and impairs completion of filling, in particular of filigree injection molds.

These undesirable processing properties of the mixture may be mitigated by using a polymer of low melt viscosity, this being achievable via relatively low molecular weight, for example. However, reducing molecular weight usually also reduces mechanical strength, as determined to ISO 527-1 and 527-2, for example.

It is an object of the present invention to provide a thermoplastic polymer which, when compared with a polymer of the prior art with the same relative viscosity determined in 1% strength by weight solution in concentrated sulfuric acid against concentrated sulfuric acid, and with the same yarn strength, determined to DIN EN ISO 2062, has improved rheological properties, observed as a lower pressure during spinning upstream of the spinning plate, and better shrinkage performance, determined to DIN 53866.

We have found that this object is achieved by means of the polymer mixture defined at the outset.

According to the invention, the thermoplastic polymer mixture comprises m polymers Pₙ, where m is a natural number greater than 1 and n is a natural number from 1 to m, and where each of the polymers has one or more functional groups present as repeat units in the polymer chain of Pₙ.

In principle, there are no upper limits on the number m. For reasons of technical and economic expediency, m should be selected from 2, 3, 4, 5, 6, 7, 8, 9, 10, 11, 12, 13, 14, 15, 16, 17, 18, 19, 20, preferably 2, 3, 4, 5, 6, 7, 8, particularly preferably 2, 3, 4, 5, and is in particular 2.

Each of the polymers Pₙ contains one or more functional groups present as repeat units in the polymer chain of Pₙ.

According to the invention, functional groups present as repeat units as in property a) of claim 1 may be one or more groups of the structure

—(R¹)ₓ—C(O)—(R²)_{y}—

where

x and y, independently of one another, are 0 or 1, and x+y=1

R¹ and R², independently of one another, are oxygen or nitrogen bonded into the main polymer chain, where there are advantageously two bonds linking the nitrogen to the polymer chain and the third bond may bear a substituent selected from the group consisting of hydrogen, alkyl, preferably C₁-C₁₀-alkyl, in particular C₁-C₄-alkyl, such as methyl, ethyl, n-propyl, isopropyl, n-butyl, isobutyl, sec-butyl, aryl, heteroaryl, or —C(O)—, and the —C(O)— group may bear another polymer chain or may bear an alkyl radical, preferably C₁-C₁₀-alkyl, in particular C₁-C₄-alkyl, e.g. methyl, ethyl, n-propyl, isopropyl, n-butyl, isobutyl, or sec-butyl, or may bear an aryl or heteroaryl radical, examples being —N—C(O)—, —C(O)—N—, —O—C(O)— or —C(O)—O—.

Besides these functional groups, there may be one or more other functional groups in the polymer chain of one or more polymers Pₙ. Groups which may be advantageously used here are those which do not impair the thermoplasticity of the polymer mixture of the invention, preferably the ether, amino, keto, sulfide, sulfone, imide, carbonate, urethane, or urea group.

Particularly preferred polymers Pₙ are polyamides, polyesters, and polyesteramides.

For the purposes of the present invention, polyamides are homopolymers, copolymers, mixtures, and grafts of synthetic long-chain polyamides which have repeat amide groups as a substantial constituent in the main polymer chain. Examples of these polyamides are nylon-6 (polycaprolactam), nylon-6,6 (polyhexamethyleneadipamide), nylon-4,6 (polytetramethyleneadipamide), nylon-6,10 (polyhexamethylenesebacamide), nylon-7 (polyenantholactam), nylon-11 (polyundecanolactam), nylon-12 (polydodecanolactam). Nylon is the known generic name for these polyamides. For the purposes of the present invention, polyamides also include those known as aramids (aromatic polyamides), such as poly-meta-phenyleneisophthalamide (NOMEX® fiber, U.S. Pat. No. 3,287,324) or poly-para-phenyleneterephthalamide (KEVLAR® fiber, U.S. Pat. No. 3,671,542).

In principle, there are two processes for preparing polyamides.

Polymerization starting from dicarboxylic acids and diamines, like polymerization starting from amino acids or from their derivatives, such as amino carbonitriles, amino carboxamides, amino carboxylic esters, or amino carboxylate salts, reacts the amino end groups and carboxy end groups of the starting monomers or starting oligomers with one another to form an amide group and water. The water may then be removed from the polymer material. Polymerization starting from carboxamides reacts the amino and amide end groups of the starting monomers or starting oligomers with one another to form an amide group and ammonia. The ammonia can then be removed from the polymer material. This polymerization reaction is usually termed polycondensation.

Polymerization using lactams as starting monomers or starting oligomers is usually termed polyaddition.

These polyamides may be obtained by processes known per se, for example those described in DE-A-14 95 198, DE-A-25 58 480, EP-A-129 196 or in: Polymerization Processes, Interscience, New York, 1977, pp. 424-467, in particular pp. 444-446, from monomers selected from the group consisting of lactams, omega-amino carboxylic acids, omega-amino carbonitriles, omega-amino carboxamides, omega-amino carboxylate salts, omega-amino carboxylic esters, or from equimolar mixtures of diamines and dicarboxylic acids, dicarboxylic acid/diamine salts, dinitriles and diamines, or a mixture of monomers of this type.

Monomers which may be used are

monomers or oligomers of a C₂-C₂₀, preferably C₂-C₁₈, arylaliphatic, or preferably aliphatic, lactam, such as enantholactam, undecanolactam, dodecanolactam, or caprolactam,

monomers or oligomers of C₂-C₂₀, preferably C₃-C₁₈, amino carboxylic acids, such as 6-aminocaproic acid or 11-aminoundecanoic acid, or else dimers, trimers, tetramers, pentamers, or hexamers thereof, or else salts thereof, such as alkali metal salts, e.g. lithium salts, sodium salts, potassium salts,

C₂-C₂₀, preferably C₃-C₁₈, amino carbonitriles, such as 6-aminocapronitrile or 11-aminoundecanonitrile, or monomers or oligomers of C₂-C₂₀ aminoamides, such as 6-aminocaproamide, 11-aminoundecanamide, and also dimers, trimers, tetramers, pentamers, and hexamers thereof,

esters, preferably C₁-C₄-alkyl esters, such as methyl, ethyl, n-propyl, isopropyl, n-butyl, isobutyl, or sec-butyl esters of C₂-C₂₀, preferably C₃-C₁₈, amino carboxylic acids, for example 6-aminocaproic esters, such as methyl 6-aminocaproate, or 11-aminoundecanoic esters, such as methyl 11-aminoundecanoate,

monomers or oligomers of a C₂-C₂₀, preferably C₂-C₁₂, alkyldiamine, such as tetramethylenediamine or preferably hexamethylenediamine, with a C₂-C₂₀, preferably C₂-C₁₄, aliphatic dicarboxylic acid or mono- or dinitriles thereof, for example sebacic acid, dodecanedioic acid, adipic acid, sebaconitrile, the dinitrile of decanedioic acid, or adiponitrile,

and also dimers, trimers, tetramers, pentamers, and hexamers of these,

monomers or oligomers of a C₂-C₂₀, preferably C₂-C₁₂, alkyldiamine, such as tetramethylenediamine or preferably hexamethylenediamine, with a C₈-C₂₀, preferably C₈-C₁₂, aromatic dicarboxylic acid or derivatives thereof, such as chlorides, e.g. 2,6-naphthalene-dicarboxylic acid, and preferably isophthalic acid or terephthalic acid,

and also dimers, trimers, tetramers, pentamers, and hexamers thereof,

monomers or oligomers of a C₂-C₂₀, preferably C₂-C₁₂, alkyldiamine, such as tetramethylenediamine or preferably hexamethylenediamine, with a C₉-C₂₀, preferably C₉-C₁₈, arylaliphatic dicarboxylic acid or derivatives thereof, such as chlorides, e.g. o-, m-, or p-phenylenediacetic acid,

and also dimers, trimers, tetramers, pentamers, and hexamers thereof,

monomers or oligomers of a C₆-C₂₀, preferably C₆-C₁₀, aromatic diamine, such as m- or p-phenylenediamine, with a C₂-C₂₀, preferably C₂-C₁₄, aliphatic dicarboxylic acid or its mono- or dinitriles, e.g. sebacic acid, dodecanedioic acid, adipic acid, sebaconitrile, the dinitrile of decanedioic acid, or adiponitrile,

and also dimers, trimers, tetramers, pentamers, or hexamers of these,

monomers or oligomers of a C₆-C₂₀, preferably C₆-C₁₀, aromatic diamine, such as m- or p-phenylenediamine, with a C₈-C₂₀, preferably C₈-C₁₂, aromatic dicarboxylic acid or derivatives thereof, such as chlorides, e.g. 2,6-naphthalenedicarboxylic acid, and preferably isophthalic acid or terephthalic acid, and also dimers, trimers, tetramers, pentamers, and hexamers thereof,

monomers or oligomers of a C₆-C₂₀, preferably C₆-C₁₀, aromatic diamine, such as m- or p-phenylenediamine, with a C₉-C₂₀, preferably C₉-C₁₈, arylaliphatic dicarboxylic acid or derivatives thereof, such as chlorides, e.g. o-, m-, or p-phenylenediacetic acid,

and also dimers, trimers, tetramers, pentamers, and hexamers thereof,

monomers or oligomers of a C₇-C₂₀, preferably C₈-C₁₈, arylaliphatic diamine, such as m- or p-xylylenediamine, with a C₂-C₂₀, preferably C₂-C₁₄, aliphatic dicarboxylic acid or mono- or dinitriles thereof, for example sebacic acid, dodecanedioic acid, adipic acid, sebaconitrile, the dinitrile of decanedioic acid, or adiponitrile,

and also dimers, trimers, tetramers, pentamers, and hexamers of these,

monomers or oligomers of a C₇-C₂₀, preferably C₈-C₁₈, arylaliphatic diamine, such as m- or p-xylylenediamine, with a C₆-C₂₀, preferably C₆-C₁₀, aromatic dicarboxylic acid or derivatives thereof, such as chlorides, e.g. 2,6-naphthalenedicarboxylic acid, and preferably isophthalic acid or terephthalic acid,

and also dimers, trimers, tetramers, pentamers, and hexamers thereof,

monomers or oligomers of a C₇-C₂₀, preferably C₈-C₁₈, arylaliphatic diamine, such as m- or p-xylylenediamine, with a C₉-C₂₀, preferably C₉-C₁₈, arylaliphatic dicarboxylic acid or derivatives thereof, such as chlorides, e.g. o-, m-, or p-phenylenediacetic acid,

and also dimers, trimers, tetramers, pentamers, and hexamers thereof,

and also homopolymers, copolymers, mixtures, and grafts of such starting monomers or starting oligomers.

In one preferred embodiment, the lactam used comprises caprolactam, the diamine used comprises tetramethylenediamine, hexamethylenediamine, or a mixture of these, and the dicarboxylic acid used comprises adipic acid, sebacic acid, dodecanedioic acid, terephthalic acid, isophthalic acid, or a mixture of these. Particularly preferred lactam is caprolactam, particularly preferred diamine is hexamethylene diamine, and particularly preferred dicarboxylic acid is adipic acid or terephthalic acid or a mixture of these.

Particular preference is given here to those starting monomers or starting oligomers which on polymerization give the polyamides nylon-6, nylon-6,6, nylon-4,6, nylon-6,10, nylon-6,12, nylon-7, nylon-11, nylon-12, or the aramids poly-meta-phenyleneisophthalamide or poly-para-phenyleneterephthalamide, in particular those which give nylon-6 or nylon-6,6.

In one preferred embodiment, one or more chain regulators may be used during the preparation of the polyamides. Chain regulators which may advantageously be used are compounds which have two or more, for example two, three or four, preferably two, amino groups reactive in polyamide formation, or have two or more, for example two, three, or four, preferably two, carboxy groups reactive in polyamide formation.

Chain regulators which may be used with advantage are dicarboxylic acids, such as C₄-C₁₀ alkanedicarboxylic acid, e.g. adipic acid, azelaic acid, sebacic acid, dodecanedioic acid, or C₅-C₈ cycloalkanedicarboxylic acids, e.g. cyclohexane-1,4-dicarboxylic acid, or benzene- or naphthalenedicarboxylic acid, such as terephthalic acid, isophthalic acid, naphthalene-2,6-dicarboxylic acid, or diamines, such as C₄-C₁₀ alkanediamines, e.g. hexamethylenediamine.

These chain regulators may bear substituents, such as halogens, e.g. fluorine, chlorine, or bromine, sulfonic acid groups or salts of these, such as lithium salts, sodium salts, or potassium salts, or may be unsubstituted.

Preference is given to sulfonated dicarboxylic acids, in particular sulfoisophthalic acid, and also to any of its salts, such as alkali metal salts, e.g. lithium salts, sodium salts, or potassium salts, preferably a lithium salt or a potassium salt, in particular a lithium salt.

Based on 1 mole of amide groups in the polyamide, it is advantageous to use at least 0.01 mol %, preferably at least 0.05 mol %, in particular at least 0.2 mol %, of a chain regulator.

Based on 1 mole of amide groups in the polyamide, it is advantageous to use not more than 1.0 mol %, preferably not more than 0.6 mol %, in particular not more than 0.5 mol %, of a chain regulator.

For the purposes of the present invention, polyesters are homopolymers, copolymers, mixtures, or grafts of synthetic long-chain polyesters whose main polymer chain has repeat ester groups as a substantial constituent. Preferred polyesters are esters of an aromatic dicarboxylic acid with an aliphatic dihydroxy compound, these being known as polyalkylene arylates, such as polyethylene terephthalate (PET) or polybutylene terephthalate (PBT).

These polyalkylene arylates are obtainable by esterifying or, respectively, transesterifying an aromatic dicarboxylic acid or an ester or an ester-forming derivative thereof with a molar excess of an aliphatic dihydroxy compound and polycondensing the resultant transesterification or esterification product in a known manner.

Preferred dicarboxylic acids which should be mentioned are 2,6-naphthalenedicarboxylic acid and terephthalic acid and mixtures of these. Up to 30 mol %, preferably not more than 10 mol %, of the aromatic dicarboxylic acid may be replaced by aliphatic or cycloaliphatic dicarboxylic acids, such as adipic acid, azelaic acid, sebacic acid, dodecanedioic acids, and cyclohexanedicarboxylic acids.

Among the aliphatic dihydroxy compounds, preference is given to diols having from 2 to 6 carbon atoms, in particular 1,2-ethanediol, 1,3-propanediol, 1,4-butanediol, 1,6-hexanediol, 1,4-hexanediol, 5-methyl-1,5-pentanediol, 1,4-cyclohexanediol, 1,4-cyclohexanedimethanol, and neopentyl glycol, and mixtures of these.

Particularly preferred polyesters (A) which should be mentioned are polyalkylene terephthalate which derives from alkanediols having from 2 to 10, preferably from 2 to 6, carbon atoms. Among these, particular preference is given to polyethylene terephthalate and polybutylene terephthalate and mixtures of these.

Preference is also given to polyethylene terephthalates and polybutylene terephthalates which contain, as other monomer units, up to 1% by weight, based on A), preferably up to 0.75% by weight, of 1,6-hexanediol and/or 5-methyl-1,5-pentanediol.

These polyalkylene terephthalates are known per se and are described in the literature. Their main chain contains an aromatic ring which derives from the aromatic dicarboxylic acid. The aromatic ring may also have substitution, e.g. by halogen, such as chlorine or bromine, or by C₁-C₄-alkyl, such as methyl, ethyl, isopropyl, n-propyl, n-butyl, isobutyl, or tert-butyl.

The reaction usually uses a molar excess of diol in order to have the desired effect on the ester equilibrium. The molar ratios of dicarboxylic acid or dicarboxylic ester to diol are usually from 1:1.1 to 1:3.5, preferably from 1:1.2 to 1:2.2. Very particular preference is given to molar ratios of dicarboxylic acid to diol of from 1:1.5 to 1:2, or else of diester to diol of from 1:1.2 to 1:1.5.

However, it is also possible to carry out the ester reaction with a smaller excess of diol in the first zone and to add appropriate further amounts of diol in the other temperature zones.

The reaction may advantageously be carried out in the presence of a catalyst. Preferred catalysts are titanium compounds and tin compounds as disclosed, inter alia, in the patent specifications U.S. Pat. No. 3,936,421 and U.S. Pat. No. 4,329,444. Preferred compounds which may be mentioned are tetrabutyl orthotitanate and triisopropyl titanate, and also tin dioctoate.

For the purposes of the present invention, polyester amides are copolymers of polyamides and polyesters which are obtainable by processes known per se based on the processes described for preparing polyamides and polyesters.

The preparation of polymers Pₙ may also be found in generalized form by way of example in Ullmann's Encyclopedia of Industrial Chemistry, 5th Edn., VCH Weinheim (Germany), Vol. A21, 1992, pp. 179-205 and 227-251.

Some of the polymers Pₙ may be thermoplastic.

All of the polymers Pₙ may be thermoplastic.

One advantageous embodiment here uses polymer mixtures in which at least 2, for example 2, 3, 4, 5, 6, 7, 8, 9, 10, 11, 12, 13, 14, 15, 16, 17, 18, 19, 20, of the polymers Pₙ are thermoplastic polymers, with the proviso that the number of thermoplastic polymers is not more than m.

In one preferred embodiment, the number of at least one species of reactive end groups (EG) of the main polymer chains, based on the total of all of these species of reactive end groups of the main polymer chains of all of the polymers Pₙ, is capable of complying with the inequality

EG<(12*log (M_{w})−E₁) [meq/kg]

where

log is a logarithm to base 10

M_{w} is the weight-average molecular weight to DIN 55672-2

and

E₁ is 20, preferably 28, in particular 32.

In one preferred embodiment, the number of at least one species of reactive end groups (EG) of the main polymer chains of at least one polymer Pₙ, based on the total of all of these species of reactive end groups of the main polymer chains of the polymer Pₙ, is capable of complying with the inequality

EG<(12*log (M_{w})−E₂) [meq/kg]

where

log is a logarithm to base 10

M_{w} is the weight-average molecular weight to DIN 55672-2

and

E₂ is 20, preferably 28, in particular 32.

In one preferred embodiment, the number of at least one species of reactive end groups (EG) of the main polymer chains of each of the polymers Pₙ, based on the total of all of these species of reactive end groups of the main polymer chains of each of the polymers Pₙ, is capable of complying with the inequality

EG<(12*log (M_{w})−E₃) [meq/kg]

where

log is a logarithm to base 10

M_{w} is the weight-average molecular weight to DIN 55672-2

and

E₃: is 20, preferably 28, in particular 32.

For the purposes of the present invention, a species of reactive end groups implies groups which can extend the main polymer chain with formation of a functional group as defined in claim 1, by reaction with a particular type of group present in one or more other chemical compounds.

Amino end groups are a species of reactive end groups whose amount may be determined, for example in polyamides, by acidimetric titration in which the amino end groups in solution in phenol/methanol 70:30 (parts by weight) are titrated with erchloric acid.

Carboxy end groups are a species of reactive end groups whose amount may be determined, for example in polyamides, by acidimetric titration in which the carboxy end groups in solution in benzyl alcohol are titrated with potassium hydroxide solution.

In an advantageous method of regulating the number of a species of reactive end groups, some or all of this species of reactive end groups bear a radical Z which blocks any reaction with the certain type of groups mentioned as present in one or more other chemical compounds, and thus blocks any extension of the main polymer chain. The radical Z here may be a certain radical or a mixture of such radicals.

The introduction of radicals Z is known per se, for example from Ullmann's Encyclopedia of Industrial Chemistry, 5th Edn., VCH Weinheim (Germany), Vol. A21, 1992, pp. 179-205 and 227-251, or from F. Fourné, Synthetische Fasern, Carl Hanser Verlag, Munich, Vienna, 1995, pp. 39 and 70. Compounds which may generally be used for capping are those in which a radical Z which has no functional group which extends the main polymer chain by forming a functional group as defined in claim 1 via reaction with one or more other chemical compounds, and which is suitable for forming a link to the main polymer chain, has been bonded to a functional group which brings about extension of the main polymer chain by forming a functional group as defined in claim 1 via reaction with one or more other chemical compounds, and which is suitable for forming a link to the main polymer chain.

These functional groups used are preferably the hydroxyl group, the amino group, or the carboxy group.

The means of linkage of Z to the main polymer chain of Pₙ is preferably a functional group of the structure

—(R³)ₐ—C(O)—(R⁴)_{b}

where

a and b, independently of one another, are 0 or 1, and a+b=1 or 2,

R³ and R⁴, independently of one another, are nitrogen or oxygen bonded into the main polymer chain, where it is advantageous for one of the three bonds of the nitrogen to have been linked to the polymer chain, and one to have been linked to Z, and for the third bond to bear a substituent selected from the group consisting of hydrogen, alkyl, preferably C₁-C₁₀-alkyl, in particular C₁-C₄-alkyl, e.g. methyl, ethyl, n-propyl, isopropyl, n-butyl, isobutyl, or sec-butyl, or aryl, heteroaryl, or —C(O)—, where the group —C(O)— may bear another polymer chain or bear an alkyl radical, preferably C₁-C₁₀-alkyl, in particular C₁-C₄-alkyl, e.g. ethyl, methyl, n-propyl, isopropyl, n-butyl, isobutyl, or sec-butyl, or bear an aryl or heteroaryl radical, examples being —N—C(O)—, —C(O)—N—, —O—C(O)—, —C(O)—O—, —O—C(O)—O—, —N—C(O)—O—, —O—C(O)—N—, —N—C(O)—N—.

Particular preference is given to a functional group of this type where a and b, independently of one another, are 0 or 1 and a+b=1, for example —N—C(O)—, —C(O)—N—, —O—C(O)— or —C(O)—O—.

In a polymer Pₙ, the radicals Z may be identical or different. The radicals Z may be identical or different for some of the polymers Pₙ.

The radicals Z may be identical or different for all of the polymers Pₙ.

Radicals Z which may be used advantageously, including the functional group required for linkage to the main polymer chain, are monocarboxylic acids, such as alkanecarboxylic acids, e.g. acetic acid or propionic acid, or benzene- or naphthalenemonocarboxylic acid, such as benzoic acid, or C₂-C₂₀, preferably C₂-C₁₂, alkylamines, such as cyclohexylamine, or C₆-C₂₀, preferably C₆-C₁₀, aromatic monoamines, such as aniline, or C₇-C₂₀, preferably C₈-C₁₈, arylaliphatic monoamines, such as benzylamine, or a mixture of such monocarboxylic acids and such monoamines, or the abovementioned chain regulators, or a mixture of such chain regulators with monocarboxylic acids or with monoamines.

A preferred radical Z, with preference in the case of polyamides and in particular in the case of polyamides regulated using dicarboxylic acids, such as terephthalic acid, and including the functional group required for linkage to the main polymer chain, preferably has the formula

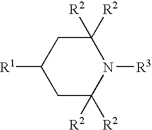

where

R¹ is a functional group capable of amide formation with respect to the main polymer chain,

preferably —(NH)R⁵, where R⁵ is hydrogen or C₁-C₈-alkyl, or carboxy, or a carboxy derivative, or —(CH₂)ₓ(NH)R⁵, where X is from 1 to 6 and R⁵ is hydrogen or C₁-C₈-alkyl, or —(CH₂)_{y}COOH, where y is from 1 to 6, or —(CH₂)_{y}COOH acid derivatives, where y is from 1 to 6,

in particular —NH₂,

R² is alkyl, preferably C₁-C₄-alkyl, such as methyl, ethyl, n-propyl, isopropyl, n-butyl, isobutyl, sec-butyl,

in particular methyl,

and R³ is hydrogen, C₁-C₄-alkyl, or O—R⁴, where R⁴ is hydrogen or C₁-C₇-alkyl,

and R³ is in particular hydrogen.

In such compounds, steric hindrance usually prevents the tertiary, or in particular secondary, amino groups of the piperidine ring systems from reacting.

Particular preference is given to 4-amino-2,2,6,6-tetramethylpiperidine.

A preferred radical Z used, with preference in the case of polyesters, and including the functional group required for linkage to the main polymer chain, is an alkali metal compound or alkaline earth metal compound, preferably sodium carbonate, sodium acetate, and advantageously sodium alkoxides, in particular sodium methoxide. Such compounds are proposed in DE-A 43 33 930.

The method for attaching such radicals Z to polyesters may be based on DE-A 44 01 055, for example, and the method for attaching such radicals Z to polyamides may be based on EP-A 759953, for example.

Each polymer Pₙ has, as property b), a number-average molecular weight Mₙ(Pₙ) to DIN 55672-2 in hexafluoroisopropanol as eluent.

Each polymer Pₙ has, as property c), a weight-average molecular weight M_{w}(Pₙ) to DIN 55672-2 in hexafluoroisopropanol as eluent.

Each polymer Pₙ has, as property d), a z-average molecular weight M_{z}(Pₙ) to DIN 55672-2 in hexafluoroisopropanol as eluent.

Each polymer Pₙ has, as property e), a heterogeneity index M_{w}(Pₙ)/Mₙ(Pₙ) to DIN 55672-2 in hexafluoroisopropanol as eluent.

Each polymer Pₙ has, as property f), a molecular weight Mₚ(Pₙ) to DIN 55672-2 in hexafluoroisopropanol as eluent.

In one preferred embodiment, the quotient calculated from the highest mass attached to a maximum in the differential distribution curve W(M) with respect to the smallest mass attached to a maximum in the differential distribution curve W(M) should be at least 2, preferably at least 5, in particular at least 10.

In another preferred embodiment, the quotient calculated from the highest mass attached to a maximum in the differential distribution curve W(M) with respect to the smallest mass attached to a maximum in the differential distribution curve W(M) should be not more than 100, preferably not more than 50.

In another preferred embodiment, the highest mass attached to a maximum in the differential distribution curve W(M) should be not more than 200,000, preferably not more than 150,000, in particular not more than 100,000.

In another preferred embodiment, the lowest mass attached to a maximum in the differential distribution curve W(M) should be at least 500, preferably at least 1000, particularly preferably at least 2500, in particular at least 5000.

For the purposes of the present invention, the measurements to DIN 55672-2 are to be carried out using a UV detector at wavelength 230 nm.

According to the invention, the polymers Pₙ differ from one another in 1, 2, 3, 4, 5, or 6 of the properties a), b), c), d), e), and f).

In one advantageous embodiment, the polymers Pₙ are identical with respect to one or more of the functional groups present as repeat units in the polymer chain Pₙ as in property a), and at the same time the polymers Pₙ differ from one another in 1, 2, 3, 4, or 5 of the properties b), c), d), e), and f).

According to the invention, the polymer mixture

has a number-average molecular weight Mₙ(P)₁, a weight-average molecular weight M_{w}(P)₁, a z-average molecular weight M_{z}(P)₁, a heterogeneity index M_{w}(P)₁/Mₙ(P)₁, and a molecular weight Mₚ(P)₁ determined to DIN 55672-2 in hexafluoroisopropanol as eluent,

and after aging of the polymer mixture at the melting point of the polymer mixture determined to ISO 11357-1 and 11357-3 for 5 minutes, preferably at least 7 minutes, in particular 10 to 30 minutes, has a number-average molecular weight Mₙ(P)₂, a weight-average molecular weight M_{w}(P)₂, a z-average molecular weight M_{z}(P)₂, a heterogeneity index M_{w}(P)₂/Mₙ(P)₂, and a molecular weight Mₚ(P)₂ determined to DIN 55672-2 in hexafluoroisopropanol as eluent, and

these values Mₙ(P)₂, M_{w}(P)₂, M_{z}(P)₂, M_{w}(P)₂/Mₙ(P)₂ and Mₚ(P)₂ lie within the value of three times the recurrent standard deviation in sigma(r) based on Mₙ(P)₁, M_{w}(P)₁, M_{z}(P)₁, M_{w}(P)₁/Mₙ(P)₁, and Mₚ(P)₁ to DIN 55672-2 in hexafluoroisopropanol as eluent.

In one preferred embodiment, the polymer mixture of the invention may, in a manner known per se, comprise additives, such as organic or inorganic, colored or non-colored additives, such as pigments or moldings.

Preferred pigments are inorganic pigments, in particular titanium dioxide, which is preferably in the anatase form, or colorant compounds which are inorganic or organic in nature, the amount preferably being from 0.001 to 5 parts by weight, in particular from 0.02 to 2 parts by weight, based on 100 parts by weight of polymer mixture. The pigments may be added to one, some, or all of the polymers Pₙ during the preparation process, or to the polymer mixture during the preparation process.

Preferred moldings are fibers or beads made from a mineral material, for example from glass, from silicon dioxide, from silicates, or from carbonates, the amount preferably being from 0.001 to 65 parts by weight, in particular from 1 to 45 parts by weight, based on 100 parts by weight of polymer mixture. The moldings may be added to one, some, or all of the polymers Pₙ during the preparation process, or to the polymer mixture during the preparation process.

The polymer mixture of the invention may be obtained by processes known per se for preparing polymer mixtures.

In one advantageous process, a mixture comprising polymers Pₙ in solid form may be melted, mixed, and allowed to solidify.

In one advantageous process, one part of the polymers Pₙ in molten or solid form may be added to the other part of the polymers Pₙ in molten form, and the melt mixed and allowed to solidify.

This solidification of the melt may be allowed to take place in any desired manner, for example to give pellets, fibers, sheets, or moldings, which may be obtained from the melt by processes known per se.

The invention also provides fibers, sheets, and moldings obtainable using a polymer mixture of the invention, for example by melting the polymer mixture and extruding it by processes known per se.

We claim:

1. A thermoplastic polymer mixture comprising m polymers Pₙ, where m is a natural number greater than 1 and n is a natural number from 1 to n [sic], where each of the polymers has
a) one or more functional groups of the structure
—(R¹)ₓ—C(O)—(R²)_{y}—
present as repeat units in the polymer chain of Pₙ
where
x and y, independently of one another, are 0 or 1, and x+y=1
R¹ and R², independently of one another, are oxygen or nitrogen bonded into the main polymer chain,
b) a number-average molecular weight Mₙ(Pₙ) to DIN 55672-2 in hexafluoroisopropanol as eluent,
c) a weight-average molecular weight M_{w}(Pₙ) to DIN 55672-2 in hexafluoroisopropanol as eluent,
d) a z-average molecular weight M_{z}(Pₙ) to DIN 55672-2 in hexafluoroisopropanol as eluent,
e) a heterogeneity index M_{w}(Pₙ)/Mₙ(Pₙ) to DIN 55672-2 in hexafluoroisopropanol as eluent, and
f) a molecular weight Mₚ(Pₙ) to DIN 55672-2 in hexafluoroisopropanol as eluent,
where one or more of the functional groups present as repeat units in the polymer chain of the polymers Pₙ as property a) is/are identical, and at the same time the polymers Pₙ differ from one another in 1, 2, 3, 4, or 5 of the properties b), c), d), e), and f),
and where the polymer mixture
has a number-average molecular weight Mₙ(P)₁, a weight-average molecular weight M_{w}(P)₁, a z-average molecular weight M_{z}(P)₁, a heterogeneity index M_{w}(P)₁/Mₙ(P)₁, and a molecular weight Mₚ(P)₁ determined to DIN 55672-2 in hexafluoroisopropanol as eluent,
and after aging of the polymer mixture at the melting point of the polymer mixture determined to ISO 11357-1 and 11357-3 for 5 minutes has a number-average molecular weight Mₙ(P)₂, a weight-average molecular weight M_{w}(P)₂, a z-average molecular weight M_{z}(P)₂, a heterogeneity index M_{w}(P)₂/Mₙ(P)₂, and a molecular weight Mₚ(P)₂ determined to DIN 55672-2 in hexafluoroisopropanol as eluent, and
these values Mₙ(P)₂, M_{w}(P)₂, M_{z}(P)₂, M_{w}(P)₂/Mₙ(P)₂ and Mₚ(P)₂ lie within the value of three times the recurrent standard deviation in sigma(r) based on Mₙ(P)₁, M_{w}(P)₁, M_{z}(P)₁, M_{w}(P)₁/Mₙ(P)₁ and Mₚ(P)₁ to DIN 55672-2 in hexafluoroisopropanol as eluent.

2. A polymer mixture as claimed in claim 1, where at least two of the polymers Pₙ are thermoplastic polymers.

3. The polymer mixture as claimed in claim 1 or 2, where the number of at least one species of reactive end groups (EG) of the main polymer chains, based on the total of all of these species of reactive end groups of the main polymer chains of all of the polymers Pₙ complies with the inequality
EG<(12*log (M_{w})−E₁) [meq/kg]
where
M_{w} is the weight-average molecular weight to DIN 55672-2 and
E₁ is 20.

4. The polymer mixture as claimed in any of claims 1 to 3, where the number of at least one species of reactive end groups (EG) of the main polymer chains of at least one polymer Pₙ, based on the total of all of these species of reactive end groups of the main polymer chains of the polymer Pₙ, complies with the inequality
EG<(12*log (M_{w})−E₂) [meq/kg]
where
M_{w} is the weight-average molecular weight to DIN 55672-2 and
E₂ is 20.

5. The polymer mixture as claimed in any of claims 1 to 4, where the number of at least one species of reactive end groups (EG) of the main polymer chains of each of the polymers Pₙ, based on the total of all of these species of reactive end groups of the main polymer chains of each of the polymers Pₙ, complies with the inequality
EG<(12*log (M_{w})−E₃) [meq/kg]
where
M_{w} is the weight-average molecular weight to DIN 55672-2 and
E₃ is 20

6. A polymer mixture as claimed in any of claims 1 to 5, where some or all of at least one species of reactive end groups bear a radical Z and Z has been linked to the main polymer chain of Pₙ by way of a functional group of the structure
—(R³)ₐ—C(O)—(R⁴)_{b}—
where
a and b, independently of one another, are 0 or 1, and a+b=1 or 2, and
R³ and R⁴, independently of one another, are nitrogen or oxygen bonded into the main polymer chain.

7. A polymer mixture as claimed in any of claims 1 to 6, also comprising a pigment or a molding.

8. A process for preparing a polymer mixture as claimed in any of claims 1 to 7, which comprises melting and mixing a mixture comprising polymers Pₙ in solid form, and allowing the mixture to solidify.

9. A process for preparing a polymer mixture as claimed in any of claims 1 to 8 [sic], which comprises adding one part of the polymers Pₙ in molten or solid form to the other part of the polymers Pₙ in molten form, and mixing the melt, and allowing it to solidify.

10. A fiber, a sheet, or a molding obtainable using a polymer mixture as claimed in any of claims 1 to 9.
